(19) United States
(12) Patent Application Publication
(10) Pub. No.: US 2009/0071808 A1
(43) Pub. Date: Mar. 19, 2009

(54) Rotary input apparatus

(75) Inventors: Eung-Cheon Kang, Hwaseong-si (KR); Min-Kyu Shin, Suwon-si (KR); Yun-Gi Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/010,320

(22) Filed: Jan. 23, 2008

(30) Foreign Application Priority Data
Sep. 17, 2007 (KR) 10-2007-0094103

(51) Int. Cl. H01H 3/08

(52) U.S. Cl. 200/336

(57) ABSTRACT

A rotary input apparatus is disclosed. A rotary input apparatus that includes a wheel which inputs information by rotation; a holder which rotatably supports the wheel; a tooth or teeth formed on any one of the wheel and the holder; and a flat spring which is supported by the other of the wheel and the holder and which catches onto the tooth to elastically support the wheel in the direction of rotation, utilizes a simple structure to allow smooth operation while implementing a clicking sensation for each section.

### CROSS-REFERENCE TO RELATED APPLICATIONS

This application claims the benefit of Korean Patent Application No. 10-2007-0094103 filed with the Korean Intellectual Property Office on Sep. 17, 2007, the disclosure of which is incorporated herein by reference in its entirety.

### BACKGROUND

1. Technical Field

The present invention relates to a rotary input apparatus.

2. Description of the Related Art

In general, a mobile terminal has the numbers 0-9 and the symbols * and # on a keypad of 12 keys. In addition to the numbers, there are also alphabet letters as well as consonants and vowels of Korean letters marked on such a keypad, to enable the input of numbers and letters. There are also navigation keys formed above the keypad equipped with a variety of functions such as searching phone numbers, writing and managing text messages, and connecting to the Internet, etc. There are various forms of rotary input apparatus, such as button types and rotary types, etc., and the use of rotary input apparatus is currently increasing, as they enable various functions such as menu browsing, etc.

Current mobile terminals are becoming more functionalized, to provide various services such as for DMB, digital camera functions, data exchange, MP3 player functions, Internet communication, etc., and accordingly, there is a demand for a rotary input apparatus which allows various multiple inputs. In addition, as design preferences of consumers call for slimmer mobile terminals, the input apparatus for multiple inputs need to be implemented in a small area.

Furthermore, the rotary input apparatus can face problems in allowing smooth operation with only a slight amount of force applied by the user, and in providing a certain clicking sensation for each section when the input apparatus is rotated.

### SUMMARY

An aspect of the invention is to provide a rotary input apparatus having a simple structure, which allows smooth operation while implementing a clicking sensation for each section.

One aspect of the invention provides a rotary input apparatus that includes a wheel which inputs information by rotation; a holder which rotatably supports the wheel; a tooth or teeth formed on any one of the wheel and the holder; and a flat spring which is supported by the other of the wheel and the holder and which catches onto the tooth to elastically support the wheel in the direction of rotation.

A lubricant may further be included between the tooth or teeth and the flat spring.

Here, the teeth can be formed continuously along an imaginary circumference facing the flat spring, while the flat spring can include a protruding portion that catches onto the tooth and a folded portion that elastically supports the protruding portion, and can be inserted in and supported by an indentation formed in the other of the wheel and the holder. The protruding portion may be separated from the folded portion by a predetermined distance.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view illustrating a rotary input apparatus according to an embodiment of the invention.

FIG. 2 is a cross-sectional view illustrating a portion of a rotary input apparatus according to an embodiment of the invention.

FIG. 3 is a top view illustrating a wheel according to an embodiment of the invention.

FIG. 4 is a cross-sectional view illustrating a wheel according to an embodiment of the invention.

FIG. 5 is a bottom view illustrating a wheel according to an embodiment of the invention.

FIG. 6 is a top view illustrating a holder according to an embodiment of the invention.

FIG. 7 is a cross-sectional view illustrating a holder according to an embodiment of the invention.

FIG. 8 is a bottom view illustrating a holder according to an embodiment of the invention.

FIG. 9 is a top view illustrating a flat spring according to an embodiment of the invention.

FIG. 10 is a front view illustrating a flat spring according to an embodiment of the invention.

FIG. 11 is a diagram illustrating the operation of a rotary input apparatus according to an embodiment of the invention.

FIG. 12 is a diagram illustrating the operation of a rotary input apparatus according to an embodiment of the invention.

FIG. 13 is a diagram illustrating the operation of a rotary input apparatus according to an embodiment of the invention.

### DETAILED DESCRIPTION

The rotary input apparatus according to certain embodiments of the invention will be described below in more detail with reference to the accompanying drawings, in which those components are rendered the same reference numeral that are the same or are in correspondence, regardless of the figure number, and redundant explanations are omitted.

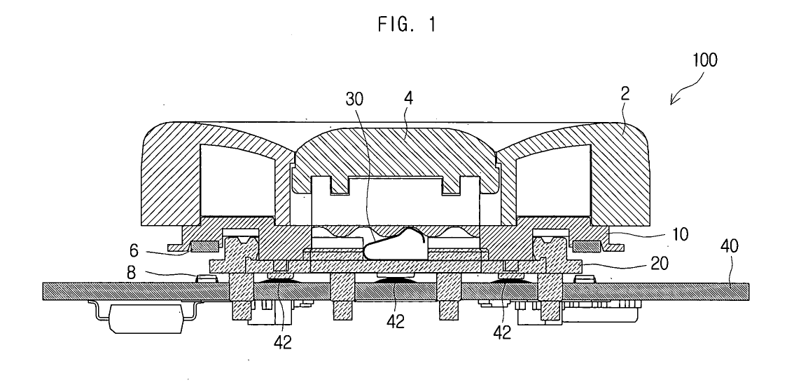

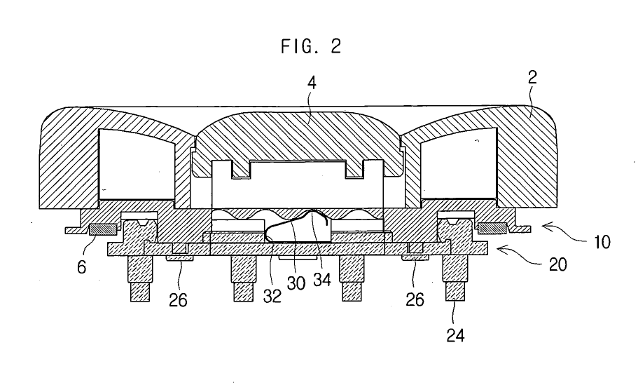

FIG. 1 is a cross-sectional view illustrating a rotary input apparatus according to an embodiment of the invention, and FIG. 2 is a cross-sectional view illustrating a portion of a rotary input apparatus according to an embodiment of the invention. In FIGS. 1 and 2 are illustrated a wheel key 2, a center key 4, a magnet 6, sensor components 8, a wheel 10, a holder 20, securing protrusions 24, holder protrusions 26, a flat spring 30, a folded portion 32, a protruding portion 34, a circuit board 40, buttons 42, and a rotary input apparatus 100.

Referring to FIG. 1, to use the rotary input apparatus 100 according to an embodiment of the invention, a user can manipulate the wheel key 2 or the center key 4, at which the buttons 42 of the circuit board 40 coupled to bottom of the holder 20 may be pressed, or the sensor components 8 may react, to allow the user to make an input.

Such a rotary input apparatus 100 can be applied not only to mobile terminals such as mobile phones, PDA's, etc., but also to information inputting devices such as those used for portable computers, MP3 players, game consoles, optical mice, etc.

A rotary input apparatus 100 according to an embodiment of the invention may include a wheel 10 which inputs information by rotation, a holder 20 which supports the wheel 10 in such a way that the wheel 10 is able to rotate, teeth 12 formed on one of the wheel 10 and the holder 20, and a flat spring 30 supported by the other of the wheel 10 and holder 20 that catches onto the teeth 12 to elastically support the wheel 10 in a direction of rotation. The rotary input apparatus 100 utilizes a simple structure to offer smooth operation and provide a constant clicking sensation for each section.

Referring to FIG. 2, a wheel key 2 is equipped on an upper portion of the wheel 10 which the user can directly manipulate. When the user rotates the wheel key 2, the wheel 10 coupled to the wheel key 2 may also be rotated in cooperation with the wheel key 2. A magnet 6 may be attached to a lower portion of the wheel 10. A certain magnetic field may be formed around the magnet 6, and there may be sensor components 8 mounted on the circuit board 40 that face the magnet 6. Rotating the wheel 10 causes the magnet 6 to rotate as well, at which the magnetic field sensed by the sensor components 8 is changed. In such manner, the sensor components 8 detect the rotation of the wheel 10, and information can be inputted accordingly.

One sensor component 8 or multiple sensor components 8 can be mounted on the circuit board 40 to detect the rotation of the wheel 10 by way of the change in magnetic field. The sensor component 8 may, for example, be a Hall sensor. The Hall sensor generates electromotive forces that are proportional to the rotation of the magnet attached to the wheel 10, which are transferred via the circuit board 40 to an external control device (not shown). Of course, the sensor components 8 for detecting the rotation of the wheel 10 are not limited to Hall sensors, and other types of sensors can be used, such as MR (magneto-resistive) sensors and GMR (giant magneto-resistive) sensors.

If a through-hole 14 is formed in the center of the wheel 10, a center key 4 can be coupled to the wheel key 2 such that the center key 4 can move up and down. A user can press the center key 4, causing the buttons 42 of the circuit board 40 to be pressed, whereby additional information can be inputted.

The buttons 42 can be dome buttons made of a metal material but are not thus limited. The buttons 42 can be implemented in a variety of ways, for example, as pressure sensors or contact sensors.

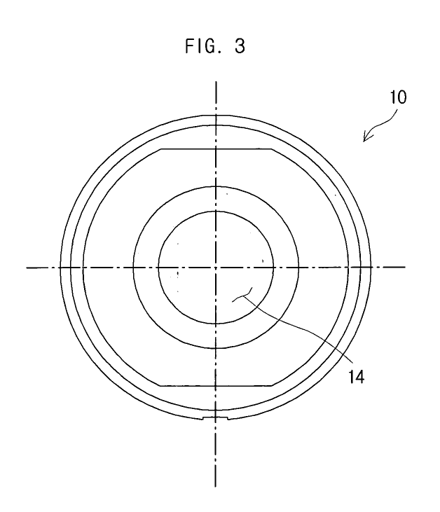

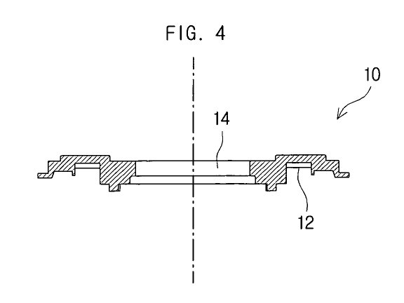

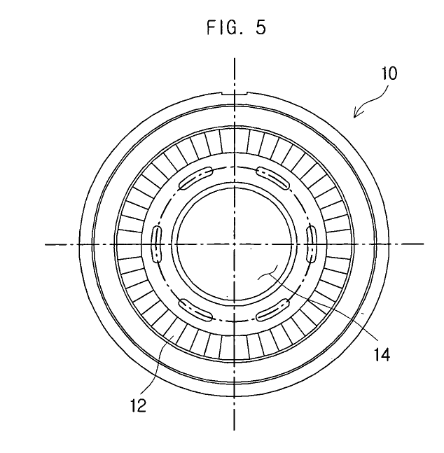

FIG. 3 is a top view illustrating a wheel 10 according to an embodiment of the invention, FIG. 4 is a cross-sectional view illustrating a wheel 10 according to an embodiment of the invention, and FIG. 5 is a bottom view illustrating a wheel 10 according to an embodiment of the invention. In FIGS. 3 to 5, the teeth 12 and the through-hole 14 are illustrated.

The wheel 10 can be coupled with the wheel key 2 and can receive input by being rotated. Referring to FIG. 3, the wheel 10 may have a generally circular shape, while a through-hole 14 may be formed in the center of the wheel 10. The center key 4 may be inserted in the through-hole 14 and can be pressed by the user. The center key 4 can then press a button 42, whereby information can be inputted.

Referring to FIGS. 4 and 5, a tooth 12 or teeth 12 can be formed in a lower portion of the wheel 10. The teeth 12 can have the form of a concave portion and a convex portion alternating repeatedly. A wave shape can be effected by the repeating concave portions and convex portions. The heights of the concave portions and convex portions can be the same. The teeth 12 can be formed continuously along the circumference. The teeth 12 can be formed to pass over a flat spring 30 arranged in an indentation 22 of the holder, as will be described later, and can be formed on a circumference having the same center as the wheel 10.

By forming the teeth 12 on a lower portion of the wheel 10, the rotary input apparatus 100 can be implemented that creates a clicking sensation, with an integrated configuration, without having to form a separate rotation contact part.

The teeth 12 can be formed on one of the wheel 10 and the holder 20. While the teeth 12 are shown formed on the wheel 10 in this embodiment, they can just as well be formed on the holder 20, in which case the flat spring 30 can be supported by the wheel 10 to catch onto the teeth 12.

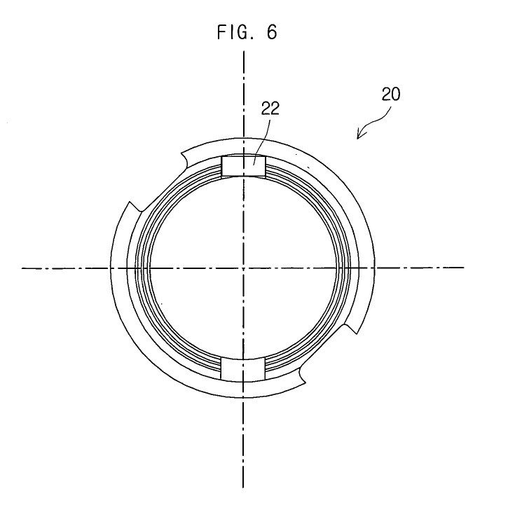

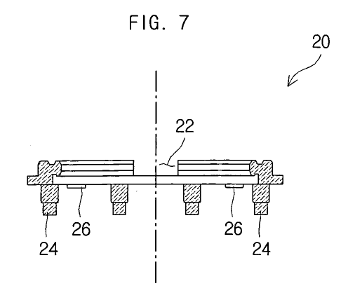

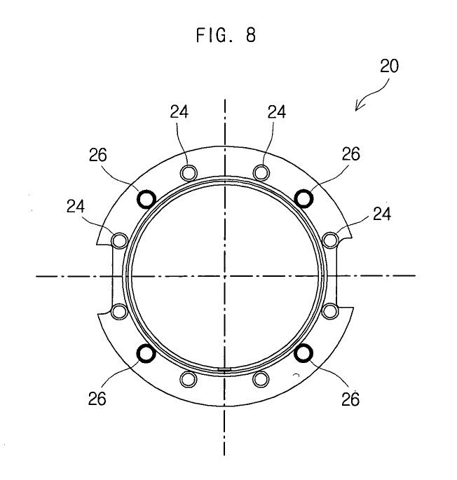

FIG. 6 is a top view illustrating a holder 20 according to an embodiment of the invention, FIG. 7 is a cross-sectional view illustrating a holder 20 according to an embodiment of the invention, and FIG. 8 is a bottom view illustrating a holder 20 according to an embodiment of the invention. In FIGS. 6 to 8 are illustrated indentations 22, securing protrusions 24, and holder protrusions 26.

The holder 20 may rotatably support the wheel 10. Referring to FIG. 6, the holder 20 can be generally circular, and may have a hole perforated in the center, in which a portion of the wheel 10 can be inserted, so that the holder 20 rotatably supports the wheel 10. On a lower portion of the holder 20, there may be securing protrusions 24 formed. The securing protrusions 24 can be formed on the lower portion of the holder 20 along the perimeter of the holder 20. The number of securing protrusions 24 may vary according to design requirements.

The securing protrusions 24 can be inserted through the circuit board 40 to provide support for the holder 20. In addition, holder protrusions 26 may be formed on a lower portion of the holder 20. The holder protrusions 26 can be formed on the positions that would be disposed above the buttons 42 when the holder 20 is installed on the circuit board 40, so that when a user presses on the wheel key 2, a holder protrusion 2 may move downwards and press a button 42 on the circuit board 40.

Indentations 22 may be formed on an upper portion of the holder 20. A flat spring 30 can be inserted in and supported by an indentation 22. The indentations 22 may be formed on an upper portion of the holder 20, in positions facing an imaginary circumference along which the teeth 12 are formed. The number of indentations 22 may vary according to the number of flat springs 30 needed. The depth of an indentation 22 can be such that provides enough space for the protruding portion 34 of the flat spring 30 to be moved up and down by the teeth 12. In addition to the space in which the protruding portion 34 can move up and down, the depth of the indentation 22 may be increased, to reduce the overall thickness of the rotary input apparatus 100.

Conversely, if the teeth 12 are formed not on a lower portion of the wheel 10 but on the side surface of the wheel 10, the indentations 22 can be formed in the inner perimeter of the holder 20 to face the teeth 12. If the indentations 22 are formed in the inner perimeter of the holder 20, the flat springs 30 inserted in the indentations 22 may support the wheel 10 in the direction of rotation from the side of the wheel 10.

While this embodiment illustrates the case of inserting the flat spring 30 in an indentation 22 to support the flat spring 30, in some cases, the flat spring 30 may be supported by the holder 20 without forming indentations 22. For example, the flat spring 30 and the holder 20 may be attached to each other by way of adhesive placed in-between, or a hole may be formed in the flat spring 30 to couple the flat spring 30 and holder 20 together by way of a bolt, etc.

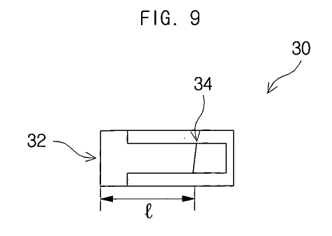

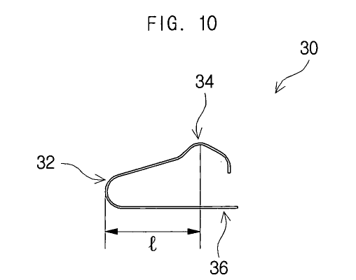

FIG. 9 is a top view illustrating a flat spring 30 according to an embodiment of the invention, and FIG. 10 is a front view illustrating a flat spring 30 according to an embodiment of the invention. In FIGS. 9 and 10 are illustrated a flat spring 30, a folded portion 32, a protruding portion 34, and a support surface 36.

The flat spring 30 catches onto one of the teeth 12 to elastically support the wheel 10 in the direction of rotation. When there are no other restraints on the wheel 10 rotatably supported by the holder 20, the wheel 10 can be perpendicular to the plane forming an upper surface of the wheel 10 and can rotate about an axis passing the center of the wheel 10. Here, the flat spring 30 can catch onto one of the teeth 12 formed on the wheel 10, to elastically support the wheel 10 in the direction of rotation.

Referring to FIG. 10, the flat spring 30 can include a protruding portion 34, which catches onto a tooth 12, and a folded portion 32, which elastically supports the protruding portion 34. The protruding portion 34 is the portion that can catch onto a tooth 12, and can be formed at one end of the flat spring 30. The protruding portion 34 can be formed by bending the flat spring 30 such that a portion protrudes out. Referring to FIG. 9, the edge made by the bent portion of the protruding portion 34 can be tilted towards the center of the wheel 10, so that the edge can be in line contact with the convex portions and concave portions of the teeth 12.

Referring to FIG. 10, the folded portion 32 refers to the portion of the flat spring 30 bent to elastically support the protruding portion 34. When a force is applied on the protruding portion 34, the degree to which the folded portion 32 is bent changes, providing an elastic force on the protruding portion 34.

The protruding portion 34 can be formed with a predetermined distance from the folded portion 32. It is desired of the rotary input apparatus to provide smooth rotation of the wheel 10, while at the same time providing a clicking sensation for each section. The clicking sensation felt by the user can be determined in part by the force with which the flat spring 30 supports the wheel 10 in the direction of rotation, which in turn is related to the elastic force of the flat spring 30.

The elastic force of the flat spring 30 will vary according to the distance (l) between the protruding portion 34 and the folded portion 32. Therefore, in order to provide smooth rotation of the wheel 10 as well as provide a clicking sensation for each section, the protruding portion 34 and the folded portion 32 can be separated by a predetermined distance.

A predetermined distance here refers to a distance that makes the distance (l) between the folded portion 32 and the protruding portion 34 be greater than or equal to one half the length of the support surface 36, by which the flat spring 30 touches the bottom of the indentation 22 and which supports the flat spring 30. Referring to FIG. 10, the flat spring 30 seen in a front view is not symmetrical. Thus, the distance (l) between the folded portion 32 and the protruding portion 34 can be adjusted within a range that exceeds one half the length of the support surface 36.

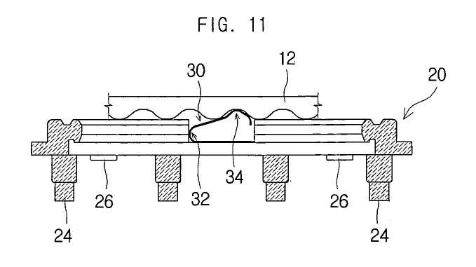

FIGS. 11 to 13 are diagrams illustrating the operation of a rotary input apparatus according to an embodiment of the invention. Referring to FIGS. 11 to 13, the flat spring 30 may catch onto a tooth 12 to provide elastic support in the direction of rotation, to provide a clicking sensation to the user. Referring first to FIG. 11, when the protruding portion 34 catches onto a concave portion of the teeth 12, the wheel 10 may be elastically supported by the elastic force of the flat spring 30 and may remain still without rotating.

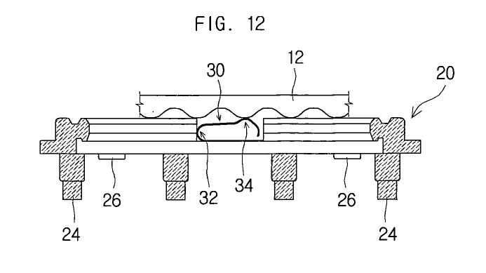

However, referring to FIG. 12, when the user applies a force in a particular direction to rotate the wheel 10, the teeth 12 formed on the lower portion of the wheel 10 move such that a convex portion of the teeth 12 press down on the protruding portion 34 of the flat spring 30. The protruding portion 34 elastically supported by the folded portion 32 is bent by the pressure of the convex portion, and the protruding portion 34 is lowered.

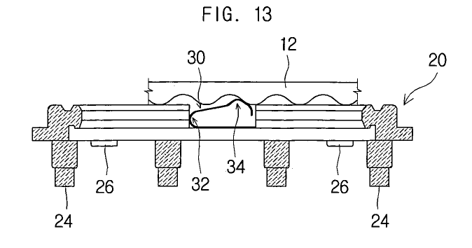

Referring to FIG. 13, when the uppermost point of the protruding portion 34 is made to pass the convex portion by the force applied in one direction by the user, the protruding portion 34 again enters a concave portion, to elastically support the wheel 10 in the direction of rotation. In this way, as the flat spring 30 moves up and down and elastically supports the wheel 10 in the direction of rotation, the user can feel a clicking sensation.

A lubricant (not shown) can be interposed between the teeth 12 and the flat springs 30, to further smoother the rotation of the wheel 10. The lubricant may not only decrease the friction between the teeth 12 and the flat spring 30 for a smoother rotation of the wheel 10, but may also reduce abrasion in the flat spring 30 and teeth 12. The lubricant can be applied on the surface of the teeth 12 or on the protruding portion 34 of the flat spring 30, to be interposed between the teeth 12 and the flat spring 30.

As set forth above, embodiments of the invention can implement a rotary input apparatus having a simple structure, which allows smooth operation and which provides a particular clicking sensation.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A rotary input apparatus comprising:
a wheel configured to input information by rotation;
a holder rotatably supporting the wheel;
a tooth formed on any one of the wheel and the holder; and
a flat spring supported by the other of the wheel and the holder and configured to catch onto the tooth and elastically support the wheel in a direction of rotation.

2. The rotary input apparatus of claim 1, further comprising a lubricant applied between the tooth and the flat spring.

3. The rotary input apparatus of claim 1, wherein the tooth are formed in a plurality, the teeth formed continuously along an imaginary circumference facing the flat spring.

4. The rotary input apparatus of claim 1, wherein the flat spring is inserted in and supported by an indentation formed in the other of the wheel and the holder.

5. The rotary input apparatus of claim 1, wherein the flat spring comprises:
a protruding portion configured to catch onto the tooth; and
a folded portion configured to elastically support the protruding portion.

6. The rotary input apparatus of claim 5, wherein the protruding portion is separated from the folded portion by a predetermined distance.
